(19) United States
(12) Patent Application Publication
(10) Pub. No.: US 2005/0286960 A1
(43) Pub. Date: Dec. 29, 2005

(54) SELF-POSITIONING GUARD OF A PRINTER FOR CONTROLLING ACCESS TO AN OPENING ON A HOUSING OF THE PRINTER

(76) Inventors: Le-Jen Wang, Taipei Hsien (TW); Yueh-Cheng Lin, Chia-Yi Hsien (TW)

Correspondence Address: NORTH AMERICA INTELLECTUAL PROPERTY CORPORATION, P.O. BOX 506, MERRIFIELD, VA, 22116, US

(21) Appl. No.: 10/710,263

(22) Filed: Jun. 29, 2004

(51) Int. Cl. B41J 29/02

(52) U.S. Cl. 400/693

(57) ABSTRACT

A self-positioning guard of a printer includes a cover for blocking an access opening of the printer and a positioning apparatus coupled to the cover for controlling movement of the cover. The cover has a plate for blocking the access opening and a hinge coupled to the plate for allowing the plate to pivot away from the access opening. The positioning apparatus has a motor for supplying a rotational motion, and a Scotch yoke coupled to the motor for converting the rotational motion into a linear motion for moving the cover.

### BACKGROUND OF INVENTION

1. Field of the Invention

The invention relates to a guard for a printer, and more particularly, to a self-positioning guard for a printer for controlling access to an opening located on a housing of the printer.

2. Description of the Prior Art

Printers all have access openings. Typically, these access openings are embodied by the places in the printer where paper is input or output. A danger of keeping the opening accessible at all times is that things such as dust may accumulate at the opening and possibly enter into the printer. The result of such actions is printer performance suffers as well as damage to the printer itself. Recently, dye diffusion thermal transfer printers have become popular owing to demands of high and long-lasting picture quality in conjunction with the water-proof characteristic of the printed picture. Regarding the prior art dye diffusion thermal transfer printer, it makes use of filters positioned on heat dissipation openings for blocking the dust from entering the printer. However, the openings for loading and ejecting sheets of print paper are wide-open without any shields so that dust is sure to enter the printer and damage the internal mechanism of the prior art dye diffusion thermal transfer printer and degrade the quality of the printed picture.

### SUMMARY OF INVENTION

It is therefore an objective of the claimed invention to provide a self-positioning guard for a printer to solve the above-mentioned problem.

According to the embodiment of the claimed invention, a self-positioning guard of a printer is disclosed. The self-positioning guard comprises a cover for blocking an access opening of the printer and a positioning apparatus coupled to the cover for controlling movement of the cover. The cover comprises a plate for blocking the access opening and a hinge coupled to the plate for allowing the plate to pivot away from the access opening. The positioning apparatus comprises a motor for supplying a rotational motion, and a Scotch yoke coupled to the motor for converting the rotational motion into a linear motion for moving the cover.

It is an advantage of the present invention that the printer has the benefit of blocking an access opening through a self-positioning guard. By blocking the opening automatically, and unblocking the opening only when needed, the printer can be saved from unnecessary wear cause by foreign matter such as dust.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a self-positioning guard within a printer according to the present invention.

FIG. 2 is a side view of the self-positioning guard shown in FIG. 1 in an off stage according to the present invention.

FIG. 3 is a side view of the self-positioning guard shown in FIG. 1 in a standby stage according to the present invention.

FIG. 4 is a side view of the self-positioning guard shown in FIG. 1 in a loading stage according to the present invention.

FIG. 5 is a side view of the self-positioning guard shown in FIG. 1 in a print stage according to the present invention.

### DETAILED DESCRIPTION

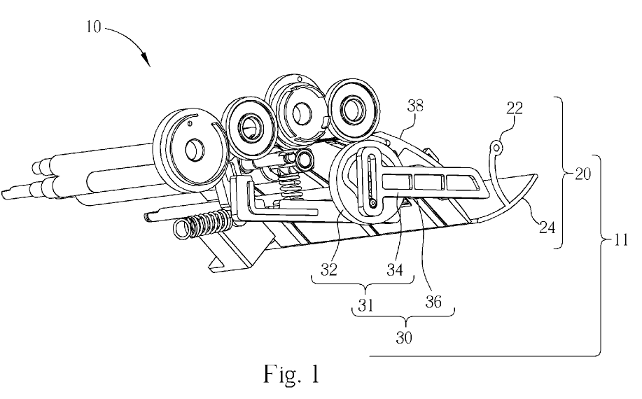

Please refer to FIG. 1. FIG. 1 is a perspective view of a self-positioning guard 11 within a printer 10 according to the present invention. The self-positioning guard 11 comprises a cover 20 and a positioning apparatus 30. In this preferred embodiment, the cover 20 comprises a hinge 22 and a plate 24, and the positioning apparatus 30 comprises a Scotch yoke 31 and a motor 36. The plate 24 is for blocking an access opening of the printer 10 and is coupled to the hinge 22; the hinge 22 can be connected to the housing of the printer 10 for allowing the plate 24 to pivot away from the access opening of the printer 10. As for the positioning apparatus 30, in this preferred embodiment, a Scotch yoke 31 is used. The Scotch yoke 31 comprises a gear 32 and an arm 34. The gear 32 is for converting rotational motion received from a coupled motor 36 into a linear motion. The arm 34, being coupled to the gear 32, is for moving the cover 20. Because the structure and operation of the Scotch yoke 31 is well-known, the related description is skipped for simplicity. Please note the remaining components shown in FIG. 1 belong to a printing mechanism positioned within the housing of the printer 10. For example, a paper-guiding plate 38 is used to guide a sheet of the print paper to move toward an access opening on the housing.

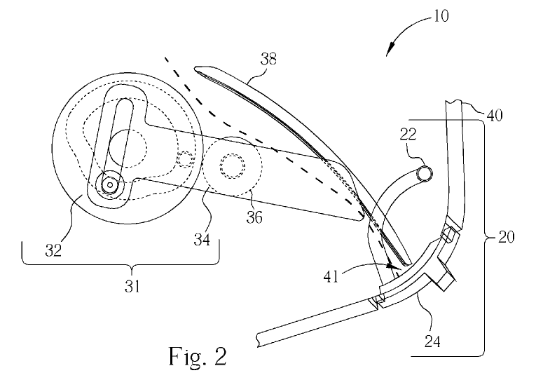

For more details about the operation of the self-positioning guard 11, please refer to FIGS. 2-5. FIGS. 2-5 are side views of the self-positioning guard 11 through various stages of printing. Present in all the figures is a thick dotted line, which represents the path of a sheet of print paper. Please note that the paper-guiding plate 38 and parts of the housing 40 of the printer 10 do not belong to the self-positioning guard 11, but are shown in FIGS. 2-5 to better define the path of the print paper and an access opening 41 located on the housing 40. FIG. 2 is a side view of the self-positioning guard 11 when the printer 10 is in the off stage. As one can see, the arm 34 of the Scotch yoke 31 is drawn to the left. At this point, the arm 34 is not in contact with the cover 20. The access opening 41, therefore, is still blocked by the cover 20.

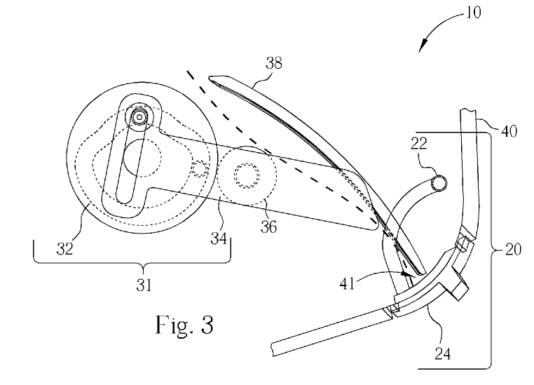

FIG. 3 is a side view of the self-positioning guard 11 when the printer 10 is in the standby stage. As one can see, when the printer 10 enters the standby stage, the motor 36 spins to drive the disc 32 of the Scotch yoke 31 to rotate, in this case the disc 32 rotates roughly 210° counterclockwise. Please note that the motor 36 is in contact with the disc 32. When the disc 32 rotates, the arm 34 lurches forward first and then back. However, compared with the location of the arm 34 shown in FIG. 2, the arm 34 shown in FIG. 3 does not move forward to make contact with the cover 20. The arm 34 in the off state and the standby state holds the same position.

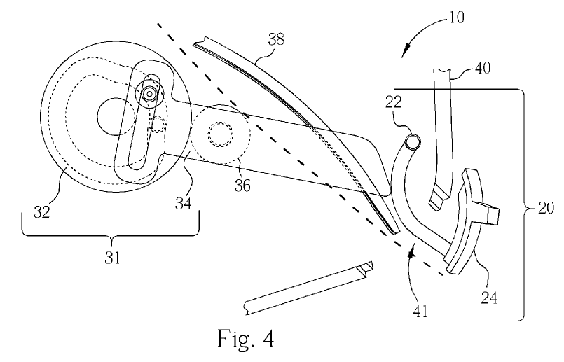

FIG. 4 is a side view of the self-positioning guard 11 when the printer 10 is in the load stage. When the printer 10 enters the load stage, the motor 36 spins again to rotate the disc 32 of the Scotch yoke 31. In the preferred embodiment, the disc 32 rotates roughly 60° clockwise, so the arm 34 moves forward in response. At this time, the arm 34 is able to make contact with the cover 32. The force from the arm 34 causes the plate 24 of the cover 20 to pivot away from the access opening 41 of the printer 10 via the hinge 22. As one can see, the path of the paper (as shown by the thick dotted line) is no longer blocked by the cover 20. In other words, when the printer 10 is in the load stage, the print paper is allowed to pass the access opening 41. If the access opening 41 is a paper-feeding entry, a sheet of print paper is capable of being loaded into the printer 10.

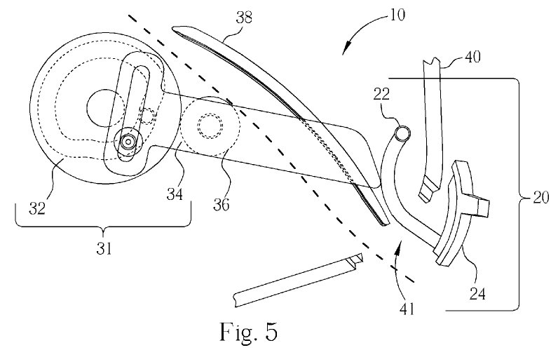

FIG. 5 is a side view of the self-positioning guard 11 when the printer 10 is in the print stage. When the printer 10 enters the print stage, the disc 32 rotates again through the motor 36. This time, the disc 32 rotates roughly 90° clockwise. The rotation of the disc 32 causes the arm 34 to move forward first and then backward. However, the arm 34 still remains in contact with the cover 20. In other words, the arm 34 still exerts a force on the cover 20, which causes the plate 24 to remain pivoted away from the access opening 41 via the hinge 22. However, compared with the location of the arm 34 shown in FIG. 4, the arm 34 shown in FIG. 5 does not leave its original position in the load state. That is, the arm 34 in the load state and the print state holds the same position. If the access opening 41 is a paper-feeding entry, a sheet of print paper loaded through the access opening 41 is capable of being printed by the printer 10. If the access opening 41 is a paper-ejecting exit, a sheet of print paper printed by a print head (not shown) is capable of being ejected from the printer 10. When the printer 10 is done with the print stage, the printer 10 reverts back to either the off stage or the standby stage as shown in FIG. 2 and FIG. 3 respectively.

The above-mentioned timing of driving the self-positioning guard 11 i.e. blocking the access opening during the off and standby stages but not blocking in the load and print stages is only meant to serve as an example and is not meant to be taken as a limitation. The timing is left to the designer of a printer to decide. In the preferred embodiment, the self-positioning guard according to the present invention is applied to a dye diffusion thermal transfer printer. However, the self-positioning guard 11 according to the present invention can be applied to any types of printers.

In contrast to the prior art, as one can see, the self-positioning guard according to the present invention has the benefit of blocking an access opening. By blocking the opening automatically, and unblocking the opening only when needed, the printer can be saved from unnecessary wear cause by foreign matter such as dust.

Those skilled in the art will readily observe that numerous modifications and alterations of the device may be made while retaining the teachings of the invention. Accordingly, that above disclosure should be construed as limited only by the metes and bounds of the appended claims.

1. A self-positioning guard of a printer comprising:
a cover for blocking an access opening of the printer; and
a positioning apparatus coupled to the cover for controlling movement of the cover;
wherein the positioning apparatus controls the cover to not block the access opening if the printer is printing.

2. The self-positioning guard of claim 1 wherein the cover comprises:
a plate for blocking the access opening; and
a hinge coupled to the plate for allowing the plate to pivot away from the access opening.

3. The self-positioning guard of claim 2 wherein the positioning apparatus drives the plate to swing via the hinge for controlling movement of the cover.

4. The self-positioning guard of claim 2 wherein the access opening is used for delivering a sheet of print paper.

5. The self-positioning guard of claim 4 wherein the access opening is a paper-feeding entry positioned on a housing of the printer or a paper-ejecting exit positioned on the housing of the printer.

6. The self-positioning guard of claim 1 wherein the positioning apparatus comprises:
a motor for supplying a rotational motion; and
a Scotch yoke coupled to the motor for converting the rotational motion into a linear motion for moving the cover.

7. The self-positioning guard of claim 6 wherein the Scotch yoke comprises:
an arm for moving the cover; and
a disc coupled to the arm and the motor for transforming the rotational motion into the linear motion.

8. The self-positioning guard of claim 1 being applied to a dye diffusion thermal transfer printer.

9. The self-positioning guard of claim 1 being positioned inside a housing of the printer.

10. A printer comprising:
a housing having an access opening;
a cover for blocking an access opening; and
a positioning apparatus coupled to the cover for controlling movement of the cover;
wherein the positioning apparatus controls the cover to not block the access opening if the printer is printing.

11. The printer of claim 10 wherein the cover comprises:
a plate for blocking the access opening; and
a hinge coupled to the plate for allowing the plate to pivot away from the access opening.

12. The printer of claim 11 wherein the positioning apparatus drives the plate to swing via the hinge for controlling movement of the cover.

13. The printer of claim 11 wherein the access opening is used for delivering a sheet of print paper.

14. The printer of claim 13 wherein the access opening is a paper-feeding entry or a paper-ejecting exit.

15. The printer of claim 10 wherein the positioning apparatus comprises:
a motor for supplying a rotational motion; and
a Scotch yoke coupled to the motor for converting the rotational motion into a linear motion for moving the cover.

16. The printer of claim 15 wherein the Scotch yoke comprises:
an arm for moving the cover; and
a disc coupled to the arm and the motor for transforming the rotational motion into the linear motion.

17. The printer of claim 10 being a dye diffusion thermal transfer printer.

18. The printer of claim 10 wherein the positioning apparatus is positioned inside the housing.
